(19) United States
(12) Patent Application Publication
(10) Pub. No.: US 2014/0187159 A1
(43) Pub. Date: Jul. 3, 2014

(54) PAIRING THROUGH DEVICE INTERACTION

(71) Applicant: Dirk Hohndel, Portland, OR (US)

(72) Inventor: Dirk Hohndel, Portland, OR (US)

(21) Appl. No.: 13/727,897

(22) Filed: Dec. 27, 2012

(51) Int. Cl. H04B 7/00

(52) U.S. Cl. CPC H04B 7/00
USPC 455/41.2

(57) ABSTRACT

Improved pairing through device interaction is generally disclosed. For example, a first device to pair with a second device using a wireless technology standard may include a transmitter to transmit wirelessly using a technology different from the wireless technology standard, and an announce engine, responsive to a user input, to selectively communicate an identification using the transmitter to indicate a request to initiate a pairing process using the wireless technology standard. In another example, a first device to pair with a second device using a wireless technology standard may include a receiver to receive wirelessly using a technology different from the wireless technology standard, and a listen engine, responsive to a user input, to listen for an identification, using the receiver, and to initiate a pairing process using the wireless technology standard with the second device indicated by the identification. In this way, one skilled in the art would appreciate that a wireless technology standard pairing algorithm would be alleviated of the potentially difficult step of identifying with which device to pair. Other embodiments are also disclosed and claimed.

### BACKGROUND

Wireless technology standards generally allow users and applications executed on electronic devices to share information between devices. Prior to exchanging information between each other, the devices must be “paired” in order to build a connection. The pairing process identifies the other mobile device to which future communications will be sent. Typically, device pairing is established using manual user interaction on both devices to identify the devices to be paired. With an increasing plethora of devices potentially within range of one another, and with limited interfaces on some devices with which to interact, this process can be cumbersome.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is a block diagram of an example environment suitable for implementing improved pairing through device interaction, in accordance with one example embodiment of the invention;

FIG. 2 is a block diagram of an example announce engine, in accordance with one example embodiment of the invention;

FIG. 3 is a block diagram of an example listen engine, in accordance with one example embodiment of the invention;

FIG. 4 is a flow chart of an example method of improved pairing through device interaction, in accordance with one example embodiment of the invention;

FIG. 5 is a flow chart of an example method of improved pairing through device interaction, in accordance with one example embodiment of the invention; and

FIG. 6 is a block diagram of an example storage medium including content which, when accessed by a device, causes the device to implement one or more aspects of one or more embodiments of the invention.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions carried by or stored on a transitory or non-transitory machine-readable (e.g., computer-readable) medium, which may be read and executed by one or more processors. A machine-readable medium may be embodied as any device, mechanism, or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements, such as those representing devices, modules, instruction blocks, and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

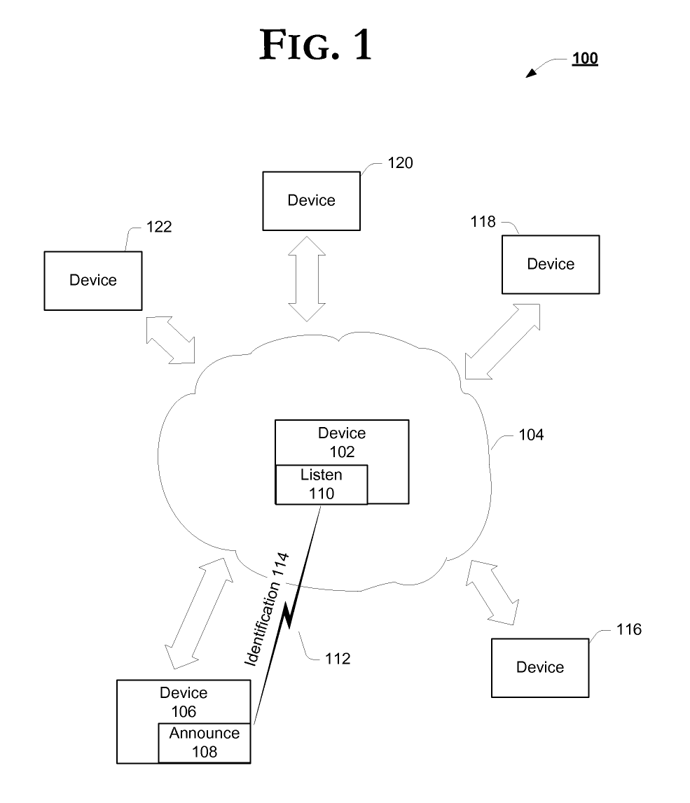

Referring now to FIG. 1, environment 100 for implementing improved pairing through device interaction includes devices 102, 106, 116, 118, 120 and 122 which may be able to communicate with one another using wireless technology standard 104 after being paired. In one example, a user may wish to pair device 106 with device 102. As part of an improved pairing process, as discussed in more detail herein, device 106 may include announce engine 108 to communicate identification 114 using a wireless technology 112 different from wireless technology standard 104. Listen engine 110 may enable device 102 to (i) identify device 106 as the device with which the user would like to establish a paired connection, and to (ii) initiate the pairing process with device 106 with less user interaction. While not shown, device 106 may also include a listen engine 110 and device 102 may also include an announce engine 108.

Wireless technology standard 104 may represent any wireless communication standard that could benefit from improved pairing through device interaction. Examples of wireless technology standard 104 may include, but are not limited to, Wi-Fi, Wi-Di, Bluetooth, Wireless USB, a local area network, a personal area network, and a body area network. Wireless technology 112 may represent different wave types or different wavelengths than wireless technology standard 104. Wireless technology 112 may represent sound waves, radio waves, infrared waves, microwaves or other wireless mediums.

Each of devices 102 and 106 may be embodied as any type of device capable of performing the functions described herein. For example, each devices 102 and 106 may be embodied as, without limitation, a mobile phone, a tablet, a laptop, a desktop, a headset, an automobile, a sensor, a speaker, an input device, a display, a computer accessory, an electronic appliance, and/or any other device configured to securely pair and exchange data.

Referring now to FIG. 2, in one embodiment, announce engine 108 includes user input module 202, identification module 204, transmitter module 206, receiver module 208, and timer module 210. The various modules of announce engine 108 may be embodied as hardware, firmware, software, or a combination thereof.

User input module 202 is configured to receive a user input to which announce engine 108 responds by invoking other modules or performing other methods. In one embodiment, user input module 202 may be responsive to a press and/or hold of a button, a software switch, or voice command.

Identification module 204 is configured to store or retrieve a device identification. Some examples of identifications include, but are not limited to, a device ID, a device name, and a device address.

Transmitter module 206 is configured to encode and transmit identification 114 over wireless technology 112. Examples of transmitter module 206 may include, but are not limited to, an audio speaker, an infrared transmitter, and an FM transmitter. Transmitter module 206 may encode identification 114 using a digital encoding scheme, for example, but not limited to, Morse code, natural language, and pulse-code modulation (PCM).

When present, receiver module 208 is configured to receive acknowledgements or communications from listen module 110. In one embodiment, receiver module 208 enables announce engine 108 to handshake with listen engine 110 to confirm receipt of identification 114.

Timer module 210 is configured to time operations so that announce engine 108 may alter functioning if necessary.

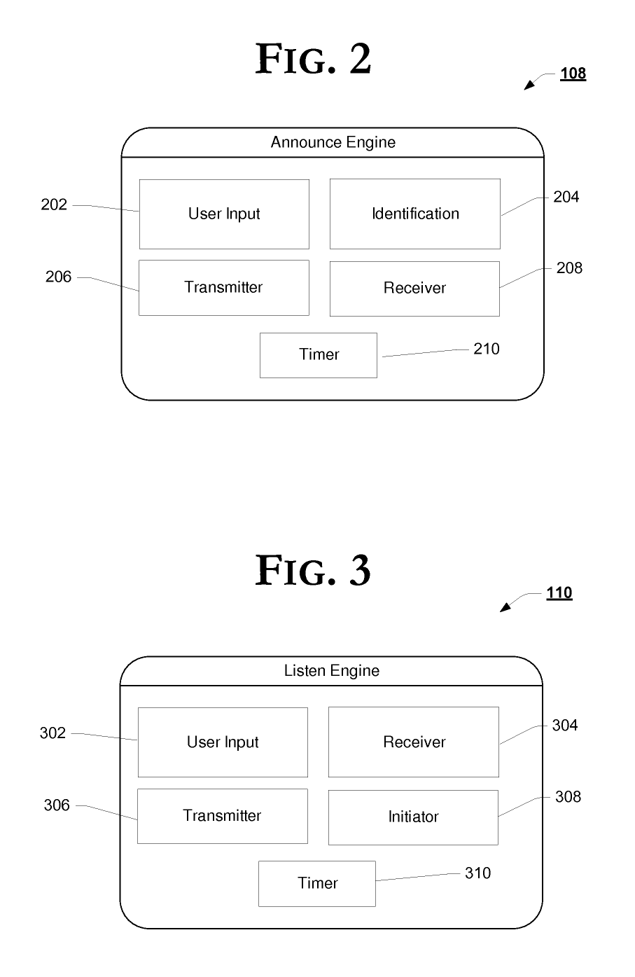

Referring now to FIG. 3, in one embodiment, listen engine 110 includes user input module 302, receiver module 304, transmitter module 306, initiator module 308, and timer module 310. The various modules of listen engine 110 may be embodied as hardware, firmware, software, or a combination thereof.

User input module 302 is configured to receive a user input to which listen engine 110 responds by invoking other modules or performing other methods. In one embodiment, user input module 302 may be responsive to a press and/or hold of a button, a software switch, or voice command.

Receiver module 304 is configured to receive and decode identification 114 over wireless technology 112. Examples of receiver module 304 may include, but are not limited to, an audio microphone, an infrared receiver, and an FM receiver. Receiver module 304 may decode identification 114 using a digital decoding scheme, for example, but not limited to, Morse code, natural language, and pulse-code modulation (PCM).

When present, transmitter module 306 is configured to send acknowledgements or communications to announce module 108. In one embodiment, transmitter module 306 enables listen engine 110 to handshake with announce engine 108 to acknowledge receipt of identification 114.

Initiator module 308 is configured to initiate pairing with device 106 after receipt of identification 114. A pairing process initiated by listen engine 110 may or may not require a PIN or other user interaction as defined by wireless technology standard 104 or by user preferences.

Timer module 310 is configured to time operations so that listen engine 110 may alter functioning if necessary.

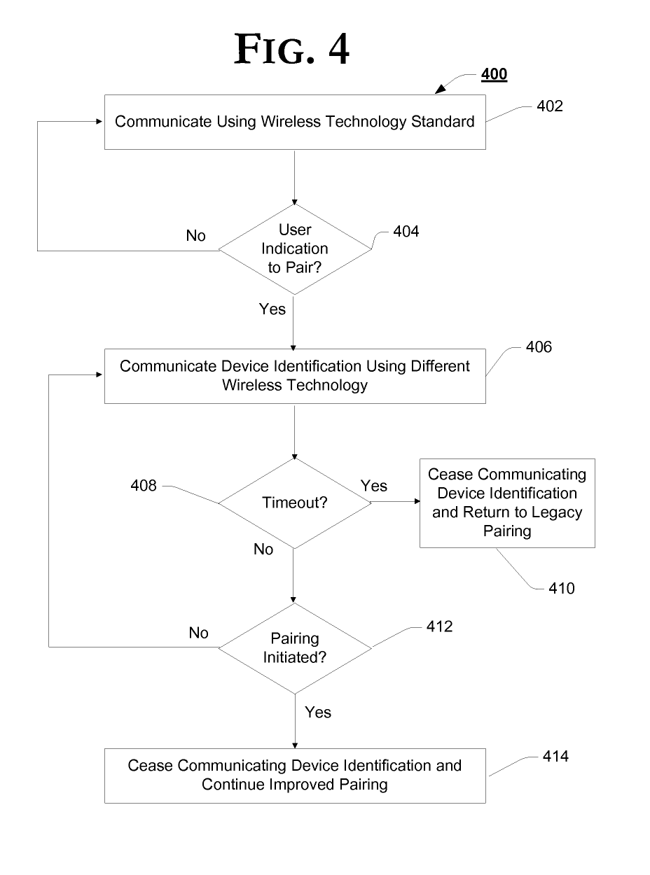

Referring now to FIG. 4, in use, device 106 may execute a method 400 for improved pairing through device interaction. The method 400 begins with block 402 in which device 106 communicates using wireless technology standard 104.

In block 404, if user input module 202 does not receive a user indication to pair, method 400 loops back to block 402. If, however, a user indication to pair is received by user input module 202, the method 400 advances to block 406 in which transmitter module 206 begins communicating identification 114 using wireless technology 112.

In block 408, announce engine 108 may invoke timer module 210 to determine whether to advance to block 412 or to cease communicating by transmitter module 206 and revert to legacy pairing (block 410).

In block 412, if device 102 has not initiated pairing with device 106, announce engine 108 may repeatedly invoke transmitter module 206 by returning to block 406.

If, however, announce engine 108 determines that pairing has been initiated by device 102, then method 400 advances to bock 414 in which transmitter module 206 ceases communicating identification 114.

Referring now to FIG. 5, in use, device 102 may execute a method 500 for improved pairing through device interaction. The method 500 begins with block 502 in which device 102 communicates using wireless technology standard 104.

In block 504, if user input module 302 does not receive a user indication to pair, method 500 loops back to block 502. If, however, a user indication to pair is received by user input module 302, the method 500 advances to block 506 in which receiver module 304 begins listening for identification 114 using wireless technology 112.

In block 508, listen engine 110 may invoke timer module 310 to determine whether to advance to block 512 or to cease listening by receiver module 304 and revert to legacy pairing (block 510).

In block 512, if device 102 has not received identification 114 from device 106, listen engine 110 may repeatedly invoke receiver module 304 by returning to block 506.

If, however, listen engine 110 has received identification 114, then method 500 advances to bock 514 in which initiator module 308 initiates pairing with device 106. In this way, one skilled in the art would appreciate that a wireless technology standard pairing algorithm would be alleviated of the potentially difficult step of identifying with which device to pair.

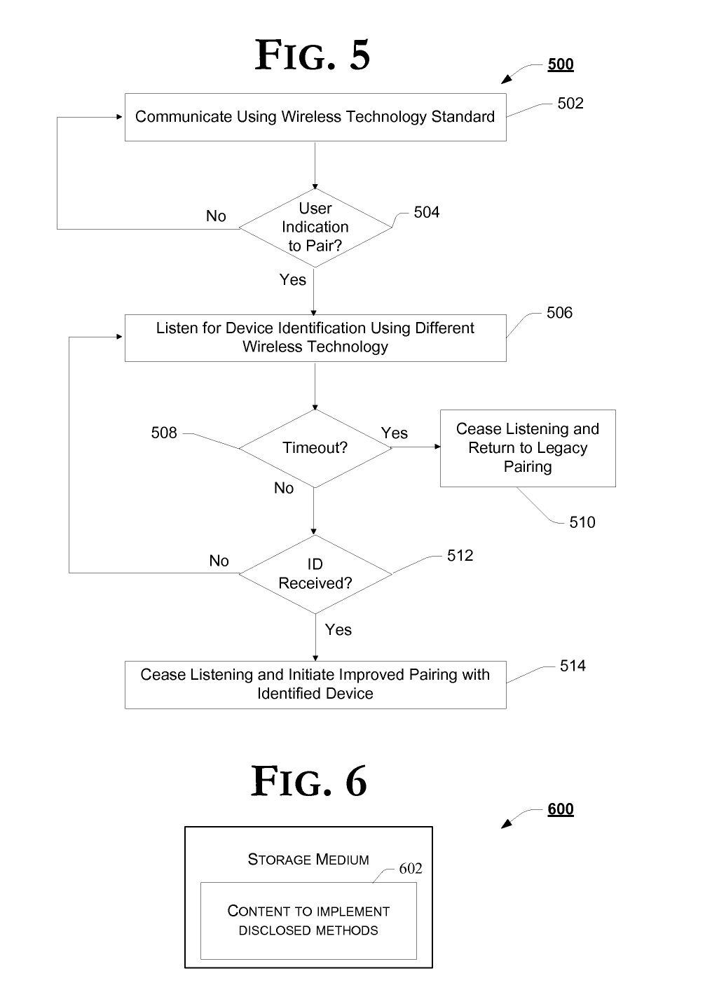

FIG. 6 is a block diagram of an example storage medium including content which, when accessed by a device, causes the device to implement one or more aspects of one or more embodiments of the invention. In this regard, storage medium 600 includes content 602 (e.g., instructions, data, or any combination thereof) which, when executed, causes the system to implement one or more aspects of methods described above.

The machine-readable (storage) medium 600 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

### EXAMPLES

Illustrative examples of the devices, systems, and methods disclosed herein are provided below. An embodiment of the devices, systems, and methods may include any one or more, and any combination of, the examples described below.

In one example, a device to pair with another device using a wireless technology standard may include a transmitter to transmit wirelessly using a technology different from the wireless technology standard, and an announce module, responsive to a user input, to selectively communicate an identification using the transmitter to indicate a request to initiate a pairing process using the wireless technology standard. In an example the wireless technology standard is chosen from the group consisting of: Wi-Fi, Wi-Di, Bluetooth, Wireless USB, a local area network, a personal area network, and a body area network. In an example, the transmitter is chosen from the group consisting of: an audio speaker, an infrared transmitter, and an FM transmitter. In an example, the device is chosen from the group consisting of: a mobile phone, a tablet, a laptop, a desktop, a headset, an automobile, a sensor, a speaker, an input device, a computer accessory, and an electronic appliance.

In an example, the device may further include a receiver, and the announce module further to handshake with the second device using the receiver to confirm receipt of the identification. In an example, the device may further include a listen module, responsive to a user input, to listen for an identification using the receiver, and to initiate a pairing process with another device indicated by the identification. In an example, the identification is chosen from the group consisting of: a device ID, a device name, and a device address. In an example, the announce module to communicate the identification comprises the announce module to encode the identification in a digital encoding format, which may be chosen from the group consisting of: Morse code, natural language, and pulse-code modulation (PCM), among others.

In another example, a first device to pair with a second device using a wireless technology standard may include a receiver to receive wirelessly using a technology different from the wireless technology standard, and a listen module, responsive to a user input, to listen for an identification, using the receiver, and to initiate a pairing process using the wireless technology standard with the second device indicated by the identification. In an example the wireless technology standard is chosen from the group consisting of: Wi-Fi, Wi-Di, Bluetooth, Wireless USB, a local area network, a personal area network, and a body area network. In an example, the receiver is chosen from the group consisting of: an audio microphone, an infrared receiver, and an FM receiver. In an example, the device is chosen from the group consisting of: a mobile phone, a tablet, a laptop, a desktop, a headset, an automobile, a sensor, a speaker, an input device, a computer accessory, and an electronic appliance.

In an example, the device may further include a transmitter, and the listen module further to handshake with the another device using the transmitter to acknowledge receipt of the identification. In an example, the device may further include an announce module, responsive to a user input, to selectively communicate an identification using the transmitter to indicate a request to initiate a pairing process. In an example, the identification is chosen from the group consisting of: a device ID, a device name, and a device address. In an example, the listen module to listen for the identification comprises the listen module to decode the identification from a digital encoding format that may be chosen from the group consisting of: Morse code, natural language, and pulse-code modulation (PCM), among others.

In another example, a machine-readable media comprising a plurality of instructions that in response to being executed result in communicating using a wireless technology standard, and communicating wirelessly, responsive to a user input, using a technology different from the wireless technology standard to indicate a request to initiate a pairing process of the wireless technology standard. In an example, communicating to indicate a request comprises communicating a device identification. In an example, communicating the device identification comprises handshaking with a listening device to confirm receipt of the device identification. In an example, communicating the device identification comprises repeatedly transmitting the device identification. In an example, further instructions result in ceasing repeatedly transmitting when the pairing process initiates.

In another example, a machine-readable media comprising a plurality of instructions that in response to being executed result in communicating using a wireless technology standard, and communicating wirelessly, responsive to a user input, using a technology different from the wireless technology standard to listen for a request to initiate a pairing process of the wireless technology standard. In an example, communicating to listen for a request comprises listening for a device identification. In an example, listening for the device identification comprises handshaking with a transmitting device to acknowledge receipt of the device identification. In an example, further instructions result in initiating the pairing process with a device indicated by the device identification. In an example, further instructions result in ceasing listening for the device identification after a timeout.

1. A first device to pair with a second device using a wireless technology standard, the device comprising:
a transmitter to transmit wirelessly using a technology different from the wireless technology standard; and
an announce engine, responsive to a user input, to selectively communicate an identification using the transmitter to indicate a request to initiate a pairing process using the wireless technology standard.

2. The device of claim 1, wherein the wireless technology standard is chosen from the group consisting of: Wi-Fi, Wi-Di, Bluetooth, Wireless USB, a local area network, a personal area network, and a body area network.

3. The device of claim 1, wherein the transmitter is chosen from the group consisting of: an audio speaker, an infrared transmitter, and an FM transmitter.

4. The device of claim 1, wherein the first device is chosen from the group consisting of: a mobile phone, a tablet, a laptop, a desktop, a headset, an automobile, a sensor, a speaker, an input device, a display, a computer accessory, and an electronic appliance.

5. The device of claim 1, further comprising:
a receiver; and
the announce engine further to handshake with the second device using the receiver to confirm receipt of the identification.

6. The device of claim 5, further comprising a listen engine, responsive to a user input, to listen for an identification using the receiver, and to initiate a pairing process with the second device indicated by the identification.

7. The device of claim 1, wherein the identification is chosen from the group consisting of: a device ID, a device name, and a device address.

8. The device of claim 1, wherein the announce engine to communicate the identification comprises the announce engine to encode the identification in a digital encoding format.

9. A first device to pair with a second device using a wireless technology standard, the device comprising:
a receiver to receive wirelessly using a technology different from the wireless technology standard; and
a listen engine, responsive to a user input, to listen for an identification, using the receiver, and to initiate a pairing process using the wireless technology standard with the second device indicated by the identification.

10. The device of claim 9, wherein the wireless technology standard is chosen from the group consisting of: Wi-Fi, Wi-Di, Bluetooth, Wireless USB, a local area network, a personal area network, and a body area network.

11. The device of claim 9, wherein the receiver is chosen from the group consisting of: an audio microphone, an infrared receiver, and an FM receiver.

12. The device of claim 9, wherein the first device is chosen from the group consisting of: a mobile phone, a tablet, a laptop, a desktop, a headset, an automobile, a sensor, a speaker, an input device, a display, a computer accessory, and an electronic appliance.

13. The device of claim 9, wherein the identification is chosen from the group consisting of: a device ID, a device name, and a device address.

14. The device of claim 9, wherein the listen engine to listen for the identification comprises the listen engine to decode the identification from a digital encoding format.

15. The device of claim 9, further comprising:
a transmitter; and
the listen engine further to handshake with the second device using the transmitter to acknowledge receipt of the identification.

16. The device of claim 15, further comprising an announce engine, responsive to a user input, to selectively communicate an identification using the transmitter to indicate a request to initiate a pairing process.

17. One or more machine-readable media comprising a plurality of instructions that in response to being executed result in:
communicating using a wireless technology standard; and
communicating wirelessly, responsive to a user input, using a technology different from the wireless technology standard to indicate a request to initiate a pairing process of the wireless technology standard.

18. The machine-readable media of claim 17, wherein communicating to indicate a request comprises communicating a device identification.

19. The machine-readable media of claim 18, wherein communicating the device identification comprises handshaking with a listening device to confirm receipt of the device identification.

20. The machine-readable media of claim 18, wherein communicating the device identification comprises repeatedly transmitting the device identification.

21. The machine-readable media of claim 20, further comprising ceasing repeatedly transmitting when the pairing process initiates.

22. One or more machine-readable media comprising a plurality of instructions that in response to being executed result in:
communicating using a wireless technology standard; and
communicating wirelessly, responsive to a user input, using a technology different from the wireless technology standard to listen for a request to initiate a pairing process of the wireless technology standard.

23. The machine-readable media of claim 22, wherein communicating to listen for a request comprises listening for a device identification.

24. The machine-readable media of claim 23, wherein listening for the device identification comprises handshaking with a transmitting device to acknowledge receipt of the device identification.

25. The machine-readable media of claim 23, further comprising initiating the pairing process with a device indicated by the device identification.

26. The machine-readable media of claim 23, further comprising ceasing listening for the device identification after a timeout.
